(19) United States
(12) Patent Application Publication
(10) Pub. No.: US 2022/0235809 A1
(43) Pub. Date: Jul. 28, 2022

(54) DRY-CONSTRUCTION SCREW

(71) Applicant: Hilti Aktiengesellschaft, Schaan (LI)

(72) Inventor: Stefan HAAG, Buchs (CH)

(21) Appl. No.: 17/613,656

(22) PCT Filed: Jun. 22, 2020
(86) PCT No.: PCT/EP2020/067307

§ 371 Date: Nov. 23, 2021

(30) Foreign Application Priority Data
Jul. 3, 2019 (EP) 19184079.2

(51) Int. Cl. F16B 25/00

(52) U.S. Cl. CPC F16B 25/0036

(57) ABSTRACT

A drywall screw for fastening a plasterboard panel to a metal support is provided, the screw having a head, a tip portion and an elongate shank, wherein the tip portion adjoins the shank, wherein the drywall screw has a widening element for widening the first borehole in the plasterboard panel to a first borehole diameter t and breaking off upon impinging the metal support, wherein the head exceeds the first borehole diameter t with a pressing-in volume V₁, wherein the shank has a thread-free underhead portion which falls below the first borehole diameter t with a receiving volume V₂ which is at least 80% of the pressing-in volume V₁.

### TECHNICAL FIELD

The invention relates to a drywall screw for fastening a plasterboard panel to a metal support.

### PRIOR ART

Such drywall screws frequently have a head, a tip portion and an elongate shank, wherein the shank defines an axis in its longitudinal direction and extends along the axis from the head to the tip portion. Known drywall screws each produce a first borehole in the plasterboard panel when the drywall screw is driven through the plasterboard panel in the direction of the axis. The drywall screw is customarily driven through the plasterboard panel to such an extent that the head does not project over a planar surface of the plasterboard panel. Here, the head displaces a certain volume of the plasterboard panel, resulting in the risk that the surface of the plasterboard panel bulges out, which adversely affects the visual impression of a smooth and planar surface.

### SUMMARY OF THE INVENTION

It is the object of the invention to provide a drywall screw in which the risk of bulging of the surface of the plasterboard panel is reduced.

The object is achieved by a drywall screw for fastening a plasterboard panel to a metal support, having a head, a tip portion and an elongate shank, wherein the shank defines an axis in its longitudinal direction and extends along the axis from the head to the tip portion, wherein the tip portion adjoins the shank and is suitable for producing a first borehole in the plasterboard panel and a second borehole in the metal support when the drywall screw is driven through the plasterboard panel in the direction of the axis, wherein the drywall screw has a widening element which is suitable for widening the first borehole in the plasterboard panel to a first borehole diameter t and breaking off upon impinging the metal support, wherein the head exceeds the first borehole diameter t with a pressing-in volume V₁, wherein the shank has a threaded portion, which is provided with a thread, and a thread-free underhead portion which is arranged along the axis between the threaded portion and the head and which falls below the first borehole diameter t with a receiving volume V₂ which is at least 80% of the pressing-in volume V₁. The receiving volume V₂ is preferably at least 100% of the pressing-in volume V₁. As a result, the thread-free underhead portion can receive material of the plasterboard panel that is displaced by the head, with the result that the risk of bulging of the surface of the plasterboard panel is reduced.

One advantageous embodiment is characterized in that the widening element comprises one or more projections. The plurality of projections are preferably distributed uniformly over a circumference of the drywall screw. It is likewise preferable for the projection(s) to be wing-shaped in form.

One advantageous embodiment is characterized in that the widening element is arranged on the threaded portion. The thread is preferably interrupted by the widening element.

One advantageous embodiment is characterized in that the widening element is arranged on the tip portion.

One advantageous embodiment is characterized in that the thread of the threaded portion continues in the tip portion.

One advantageous embodiment is characterized in that the thread of the threaded portion is suitable for forming a counter-thread into the second borehole in the metal support.

One advantageous embodiment is characterized in that the thread of the threaded portion has an outside diameter d₁ which is at most 120% of the first borehole diameter. The outside diameter d₁ is preferably at most 100% of the first borehole diameter t.

One advantageous embodiment is characterized in that the head has a cutting element for cutting a cardboard lining of the plasterboard panel. The cutting element is preferably arranged on an underside of the head that faces toward the tip portion. It is likewise preferable for the cutting element to comprise one or more sawtooth-shaped, first cutting edges which are particularly preferably arranged so as to be distributed uniformly over a circumference of the drywall screw. It is likewise preferable for the cutting element to comprise one or more spiral, second cutting edges which are particularly preferably arranged so as to be distributed uniformly over the circumference of the drywall screw. The one or more second cutting edges are particularly preferably oriented oppositely to the thread of the threaded portion.

### BRIEF DESCRIPTION OF THE SEVERAL VIEWS OF THE DRAWINGS

FIG. 1 shows a drywall screw in a side view, and

FIG. 2 shows a head of a drywall screw in a side view.

### EXEMPLARY EMBODIMENTS

The invention will be explained in more detail below on the basis of exemplary embodiments with reference to the drawings.

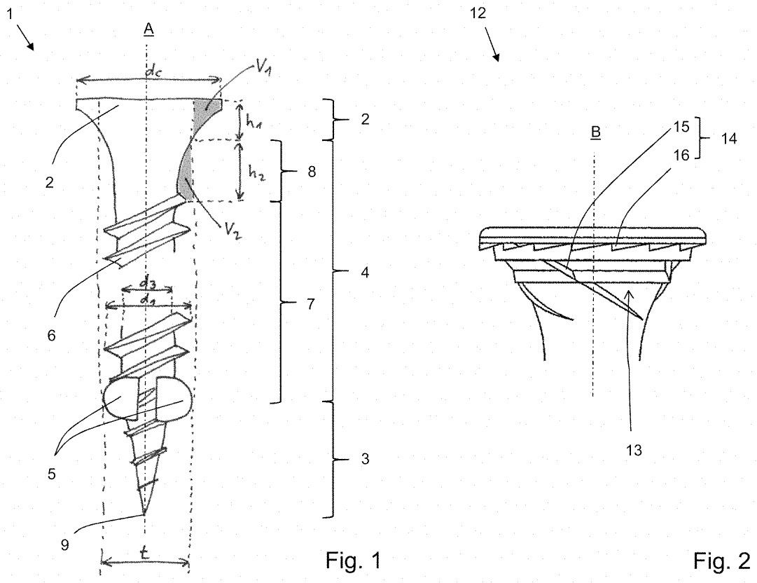

FIG. 1 illustrates a drywall screw 1 for fastening a plasterboard panel (not shown) to a metal support (likewise not shown). The drywall screw comprises a head 2, a tip portion 3 having a tip 9, and an elongate shank 4. The shank 4 has a shank diameter d₃, defines an axis A in its longitudinal direction and extends along the axis A from the head to the tip portion 3, which adjoins the shank 4. The tip portion 3 is suitable for producing a first borehole in the plasterboard panel and a second borehole in the metal support when the drywall screw 1 is driven through the plasterboard panel in the direction of the axis A. The drywall screw 1 also has a widening element 5 which comprises two wing-shaped projections situated opposite one another with respect to the axis A and which is suitable for widening the first borehole in the plasterboard panel to a first borehole diameter t which is predetermined by a radial extent of the widening element 5 with respect to the axis A. Upon impinging the metal support, however, the widening element 5 breaks off.

The head 2 has a diameter d_{c} and exceeds the first borehole diameter t with a pressing-in volume V₁, which is symmetrical with respect to the axis A, that is to say annular, and of which only a cross-sectional area can be seen in FIG. 1. The head 2 has a height h₁ in the direction of the axis A. The shank 4 has a threaded portion 7, which is provided with a thread 6, and a thread-free underhead portion 8 which is arranged along the axis A between the threaded portion 7 and the head 2. The underhead portion 8 falls below the borehole diameter t with a receiving volume V₂, of which only a cross-sectional area can likewise be seen in FIG. 1. The underhead portion 8 has a height h₂ in the direction of the axis A. The receiving volume V₂ is for example 110% of the pressing-in volume V₁. As a result, the thread-free underhead portion 8 can receive material of the plasterboard panel that is displaced by the head 2. In exemplary embodiments that have not been shown, the receiving volume V₂ is less than 100% of the pressing-in volume V₁. By virtue of the fact that the displaced material of the plasterboard panel can be compressed to a certain degree, the underhead portion can nevertheless receive the material under certain circumstances.

The widening element 5 is arranged at a transition from the shank 4 to the tip portion 3 and thus is arranged on the threaded portion 7 of the shank 4 and on the tip portion 3. The thread 6 continues in the tip portion 3, is interrupted only by the widening element 5 and preferably extends to the tip 9. The thread 6 is configured as a self-forming, in particular self-tapping, thread and is therefore suitable for forming a counter-thread into the second borehole in the metal support. The thread 6 of the threaded portion 7 has an outside diameter d₁ which is approximately 90% of the first borehole diameter t. At the thread root of the thread 6, the threaded portion 7 has the shank diameter d₃. The first borehole diameter t is preferably larger than the shank diameter d₃. In exemplary embodiments that have not been shown, the outside diameter d₁ is more than 100% of the first borehole diameter t. The thread then cuts a counter-thread into the material of the plasterboard panel under certain circumstances, although this causes no further interference.

FIG. 2 illustrates a head 12 of a drywall screw (not shown further) in a side view. The drywall screw has a tip portion (not shown) with a tip which in FIG. 2 is situated below the head 12. On an underside 13 of the head 12 that faces toward the tip portion there is arranged a cutting element 14 for cutting a cardboard lining of the plasterboard panel. The cutting element 14 comprises a plurality of sawtooth-shaped, first cutting edges 15 which are arranged so as to be distributed uniformly over a circumference of the drywall screw and which project in the direction of the axis B from the circumference of the drywall screw. Furthermore, the cutting element 14 comprises a plurality of spiral, second cutting edges 16 which are likewise arranged so as to be distributed uniformly over the circumference of the drywall screw and which are oriented oppositely to a thread of a threaded portion of the drywall screw.

The features of the embodiments described can be combined with one another in any desired manner within a single drywall screw. It is pointed out that the device according to the invention is also suitable for other purposes.

1. A drywall screw for fastening a plasterboard panel to a metal support, the drywall screw having a head, a tip portion and an elongate shank, wherein the shank defines an axis in a longitudinal direction of the shank and extends along the axis from the head to the tip portion, wherein the tip portion adjoins the shank and is suitable for producing a first borehole in the plasterboard panel and a second borehole in the metal support when the drywall screw is driven through the plasterboard panel in the direction of the axis, wherein the drywall screw has a widening element which is suitable for widening the first borehole in the plasterboard panel to a first borehole diameter t and breaking off upon impinging the metal support, wherein the head has a diameter that exceeds the first borehole diameter t with a pressing-in volume V₁, wherein the shank has a threaded portion, which is provided with a thread, and a thread-free underhead portion which is arranged along the axis between the threaded portion and the head and which falls below the first borehole diameter t with a receiving volume V₂ which is at least 80% of the pressing-in volume V₁.

2. The drywall screw as claimed in claim 1, wherein the receiving volume V₂ is at least 100% of the pressing-in volume V₁.

3. The drywall screw as claimed in claim 1, wherein the widening element has one or more projections over a circumference of the drywall screw.

4. The drywall screw as claimed in claim 3, wherein the one or more projections is or are wing-shaped in form.

5. The drywall screw as claimed in claim 1, wherein the widening element is arranged on the threaded portion.

6. The drywall screw as claimed in claim 1, wherein the thread is interrupted by the widening element.

7. The drywall screw as claimed in claim 1, wherein the widening element is arranged on the tip portion.

8. The drywall screw as claimed in claim 1, wherein the thread of the threaded portion continues in the tip portion.

9. The drywall screw as claimed in claim 1, wherein the thread of the threaded portion is suitable for forming a counter-thread into the second borehole in the metal support.

10. The drywall screw as claimed in claim 1, wherein the thread of the threaded portion has an outside diameter d₁ which is at most 120% of the first borehole diameter t.

11. The drywall screw as claimed in claim 1, wherein the head has a cutting element for cutting a cardboard lining of the plasterboard panel.

12. The drywall screw as claimed in claim 11, wherein the cutting element is arranged on an underside of the head that faces toward the tip portion.

13. The drywall screw as claimed in claim 11, wherein the cutting element comprises one or more sawtooth-shaped, first cutting edges over a circumference of the drywall screw.

14. The drywall screw as claimed in claim 11, wherein the cutting element comprises one or more spiral, second cutting edges over a circumference of the drywall screw.

15. The drywall screw as claimed in claim 14, wherein the one or more spiral, second cutting edges are oriented oppositely to the thread of the threaded portion.

16. The drywall screw as claimed in claim 3, wherein the one or more projections are distributed uniformly over the circumference of the drywall screw.

17. The drywall screw as claimed in claim 10, wherein the outside diameter d1 is at most 100% of the first borehole diameter t.

18. The drywall screw as claimed in claim 13, wherein the one or more sawtooth-shaped, first cutting edges are distributed uniformly over the circumference of the drywall screw.

19. The drywall screw as claimed in claim 14, wherein the one or more spiral, second cutting edges are distributed uniformly over the circumference of the drywall screw.

20. The drywall screw as claimed in claim 12, wherein the cutting element comprises one or more sawtooth-shaped, first cutting edges over a circumference of the drywall screw.
